(19) United States
(12) Patent Application Publication
(10) Pub. No.: US 2026/0026665 A1
(43) Pub. Date: Jan. 29, 2026

(54) AUTOMATED DRAINPIPE CLEARING SYSTEMS WITH SELF-CLEANING CHECK VALVES AND METHODS THEREFORE

(71) Applicant: Brian Runge, West Palm Beach, FL (US)

(72) Inventor: Brian Runge, West Palm Beach, FL (US)

(21) Appl. No.: 19/279,671

(22) Filed: Jul. 24, 2025

Related U.S. Application Data
(60) Provisional application No. 63/675,075, filed on Jul. 24, 2024.

(51) Int. Cl. A47L 7/00; A47L 9/24; A47L 9/28; F16K 15/18; F24F 13/22

(52) U.S. Cl. CPC A47L 7/0004; A47L 9/242; A47L 9/248; A47L 9/2842; F16K 15/18; F24F 13/222; F24F 2013/227

(57) ABSTRACT

An automated drainpipe clearing device is attached to the downstream end of a drainpipe. It includes a check valve and a suction conduit upstream from the check valve connected to a vacuum source. The check valve closes when suction is applied to the drainpipe through the section conduit. A controller allows the device to be programmed to automatically apply suction to a drainpipe for a predetermined amount of time at predetermined intervals. By periodically applying suction to the drainpipe, debris, mildew and mold are cleared from the drainpipe so that it does not clog. The check valve has a free-floating check valve and is self-cleaning.

### BACKGROUND OF THE INVENTION

### Field of the Invention

The present invention relates to an automated device or clearing a drainpipe. More particularly, the invention relates to periodically applying suction to a drainpipe to remove debris and prevent clogging.

### Description of the Related Art

An air-conditioning drain line is essential for any air conditioning system located inside a house or other building. As an air-conditioning system cools air, water naturally condenses on the evaporation coil. The hotter and more humid the ambient air, the more water condensation there is. This condensed water is collected in a drain pan below the air conditioner. A drain pipe or drain line leads carries the condensed water from the drain pan to outside a house or other structure where it can be absorbed by the ground.

Unfortunately, drainpipes tends to get clogged by debris that falls into the drain pan and by mold and mildew which grow in a humid environment. When the drainpipe is clogged, water spills out of the drain pan, causing damage. Many air-conditioners today are equipped with a kill switch attached to a float in the drain pan. When the water level in the drain pan gets too high, the air conditioner shuts off. This prevents damage but also means that the occupants of a building no longer have air-conditioning. Drainpipes and hot and humid environments are more likely to get clogged more often, meaning that people who need air conditioning the most can lose it more frequently and without any real warning. Further, there is rarely little if any warning that a drainpipe is becoming clogged.

While metal oxides contribute to blockages along with micro-organisms in air conditioning condensate drains, the primary culprit is often another natural process, the breakdown of organic matter. In this case specifically the breakdown of tissue. Take a cup of water, put it on your counter and leave it there for an extended period of time. Of course we will experience evaporation. However, we will also observe a white film on the surface. This is dead skin cells landing in the cup and breaking down into a jelly substance. Society is beginning to learn from the plumbing industry that this substance can bear a common name of “Bio-slime”. The slime sticks to the walls of the drain and begins to create a blockage. This is more so true in residential applications. In commercial applications, due to pipe construction sometimes being Iron, mass amounts of corrosion outproduces any bioslime production.

Procrastination, we humans are simply just busy bees. Millions of Americans own single family homes in hot climates. Every home is subjected to different rates of bio-slime production. More people in a home can simply just create more slime. Some create so much bio-slime that systems must be cleaned monthly. Many people cope with these problems by clearing the blockages themselves or calling a professional. However, this results in high costs, inconvenient timing and/or water damage. With costs of service men continuing rise, there is a need to ameliorate these ongoing issues.

Once a drainpipe becomes clogged it must be cleared. This is most often accomplished by an air-conditioning professional. In hot and humid environments, air conditioning professionals are in high demand and it may be a day or more before one is available to clear a clogged drain pipe. This problem is not limited to drainpipes for air-conditioning systems. A wide range of drainpipes for disposing of unwanted water may similarly be clogged without notice, causing at best inconvenience and at worst substantial damage.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide a means of efficiently and cost-effectively preventing clogged air-conditioning drainpipes.

### BRIEF SUMMARY OF THE INVENTION

Disclosed is an automated drainpipe clearing device for maintaining an air-conditioning or other drainpipe and preventing clogging. The system of the invention automatically routinely applies vacuum pressure sufficient to hear a drainpipe of debris to prevent clogging.

In one embodiment, an automated drainpipe clearing device includes an axial flow check valve at the downstream end of a drainpipe, a suction conduit in fluid communication with the drainpipe upstream of the check valve and connected to a vacuum source, and a controller for activating the vacuum source for a predetermined time period at predetermined intervals. The check valve closes only when the vacuum source is activated.

In another embodiment, the automated drainpipe clearing device includes a T junction housing the check valve and the vacuum conduit and which may be attached to the downstream end of the drainpipe.

It is therefore an object of the present invention to provide an inexpensive and reliable system for maintaining a drainpipe and preventing clogging of the drainpipe.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagrammatic view of an automated drainpipe clearing device in accordance with the principles of the invention;

FIG. 2 is a side cross-sectional view of a T junction for an automated drainpipe clearing device in accordance with the principles of the invention;

FIG. 3 is a side cross-sectional view of an alternative embodiment of a T junction for an automated drainpipe clearing device in accordance with the principles of the invention;

FIG. 4 is a top perspective view of a controller for an automated drainpipe clearing device in accordance with principles of the invention;

FIG. 5 is an environmental perspective view of an automated drainpipe clearing device attached to a drainpipe in accordance with principles of the invention;

FIG. 6 is a top perspective view of an automated drainpipe clearing device housed inside a case in accordance with principles of the invention;

FIG. 7 is an environmental view of an automated drainpipe clearing device in accordance with principles of the invention;

FIG. 8 is a diagrammatic view of an alternative embodiment of an automated drainpipe clearing device in accordance with principles of the invention;

FIG. 9 is another diagrammitc view of an automated drainpipe clearing device in accordance with the principles of the invention;

FIG. 10 is a cut-away view of a check valve for an automated drainpipe clearing device in accordance with the principles of the invention;

FIG. 11 is a cross sectional view of an alternative embodiment of a check valve for an automated drainpipe clearing device in accordance with the principles of the invention;

FIG. 12 is a cut-away view of an alternative embodiment of a check valve for an automated drainpipe clearing device in accordance with the principles of the invention;

FIG. 13 is a cut-away view of another alternative embodiment of a check valve for an automated drainpipe clearing device in accordance with the principles of the invention;

FIG. 14 is a cut-away view of another alternative embodiment of a check valve for an automated drainpipe clearing device in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise. However, no definition should be regarded as superceding any art-accepted understanding.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

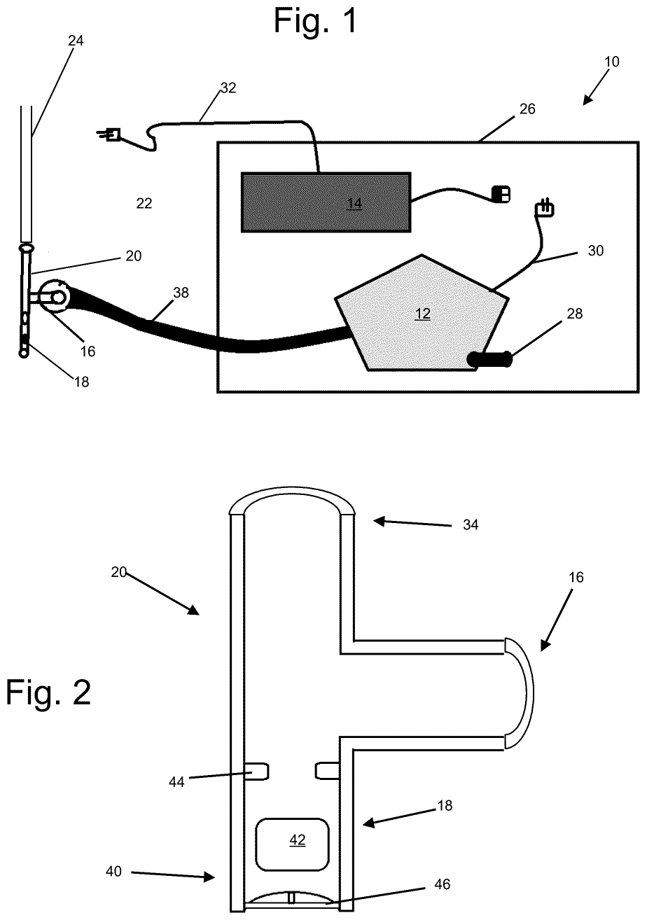

FIG. 1 shows an automated drainpipe clearing device 10 in accordance with principles of the invention. The automated drainpipe clearing device 10 includes a vacuum source 12, a controller 14, a suction conduit 16 and an axial flow check valve 18. In this embodiment, the suction conduit 16 and check valve 18 are incorporated into a T junction 20 that may be attached to a downstream end 22 of a drainpipe 24. The vacuum source 12 and controller 14 are optionally housed within a case 26. The vacuum source 12 itself includes a drainpipe 28 with its own internal check valve. Both the vacuum source 12 and the controller 14 include power cords 30 and 32, respectively. Optionally, a lawn timer, e.g. timers used to control sprinkler systems, pool pumps, etc, may be used to as a controller.

FIG. 2 shows the T junction 20 in more detail. In this embodiment, the T junction 20 is a common PVC T junction connector. However, those skilled in the art will appreciate that there are a wide variety of connectors that may be suitable for use with the invention. A first end 34 of the T junction 20 is attached to the downstream end of a drainpipe. A second end 36 is attached to a flexible hose 38 which provides fluid communication between the drainpipe 24 and the vacuum source 12. A third end 40 includes an axial flow check valve 18 configured to close only when suction is applied to the drainpipe 28 by the vacuum source 12.

In this embodiment, the check valve 18 includes a free-floating plug 42 between an upper gasket 44 and a lower grate 46. The check valve 18 is oriented such that the free-floating plug 42 lies against the grate 46 and allows water flowing out of a drainpipe into the first end 34 and out of the third end 40. When suction is applied through the second end 36, the free-floating plug 42 is pulled upward and impinges against the gasket 44, creating a seal.

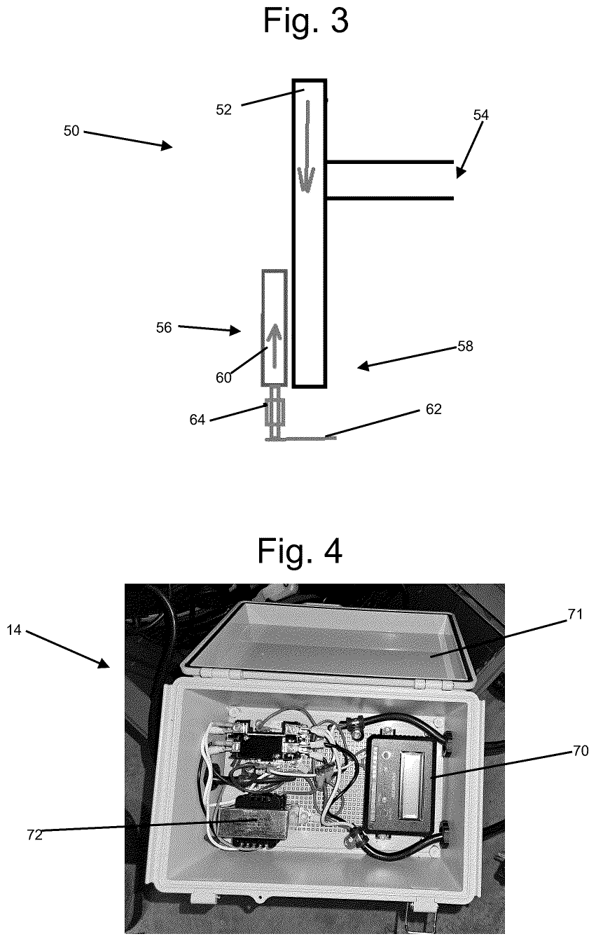

FIG. 3 shows an alternative embodiment of a T junction 50 for use with an automated drainpipe clearing device. T junction 50 also includes a first end 52 which is connected to the downstream end of a drainpipe, a second end 54 attached to a vacuum source, and a check valve 56 at a third end 58. In this embodiment, the check valve 56 is not actuated and translated into the closed position by the suction applied by the vacuum source. In this embodiment, an electronically actuated piston 60 is attached to a baffle 62 below the third end 58. In addition to gravity, a spring 64 holds the baffle 62 away from the third and 58. When the vacuum source is actuated, the check valve 56 is also actuated, pulling the baffle 62 into a configuration flush against the third and 58. Check valve 18 shown in FIG. 2 may be preferable when the T junction is oriented such that the first and third ends are aligned vertically, check valve 56 may be preferable when the T junction is in a different orientation.

By incorporating the check valve and the suction conduit into a single T junction, the process of adapting the automated clearing device to an existing drainpipe is simplified. However, those skilled in the art will appreciate that the check valve and the suction conduit may be attached to a drainpipe separately, so long as the suction conduit is upstream from the check valve. It is generally preferable for the suction conduit to be adjacent to or close to the check valve so that a clogged is not formed downstream from the suction conduit. Any debris or undesirable material drawn out of the drainpipe by the suction conduit will collect in a chamber in the vacuum source. The chamber may include its own separate drainpipe and check valve, as shown in FIG. 1 above. It may be desirable to occasionally clean the internal chamber of the vacuum source. However, this will be necessary only very rarely and the clearing device may operate for several months or years without requiring cleaning of the interior chamber of the vacuum source.

FIG. 4 shows the controller 14 for an automated drainpipe clearing device 10 in accordance with the principles of the invention. The controller 14 may be located in its own housing 71 and may be preprogrammed with a frequency and duration for actuating the vacuum source. This embodiment uses an annual digital 24 V AC relay timer 70, a 120V to 24V AC transformer 72 and additional electronics. The controller 14 may be connected to the power cords 34 the vacuum source 12. An operator programs the controller to activate the vacuum source for a predetermined duration and a time interval between activations. For example, the controller may be programmed to activate the vacuum source for two minutes once every four weeks. The controller may also optionally be used to control the amount of suction applied. When the vacuum source is activated, the check valve closes and any material within the drainpipe is sucked into the vacuum source. This removes mold, mildew, debris and any other undesirable material in the drainpipe on a regular basis. An operator may adjust the automated drainpipe clearing device 10 to optimize its application according to the particular drainpipe being maintained.

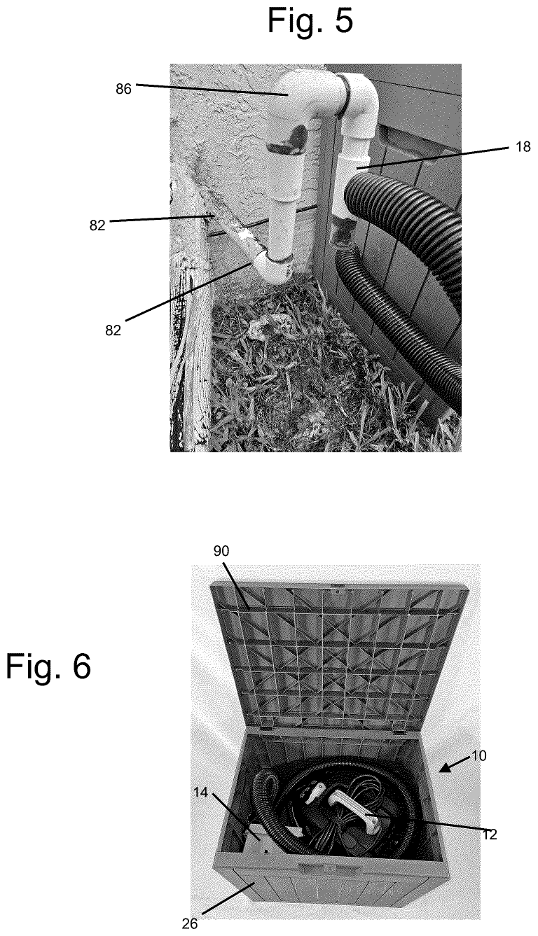

FIG. 5 shows an automated drainpipe clearing device 10 affixed to an air-conditioning drainpipe 80 in accordance with principles of the invention. In this embodiment, the downstream end 82 of the drainpipe 80 extends horizontally away from a house 84 and a height too low for the T junction 18 to be attached. Therefore, a sigmoidal pipe section 86 is first attached to the downstream end 82 of the drainpipe 80. The T junction 18 is then attached to the end of the sigmoidal pipe section 86. This allows a key junction 18 to be attached in an orientation optimal for the check valve. Those skilled in the art will appreciate that this configuration is similar to a P- or a S-trap used in plumbing that prevents airflow through the drainpipe.

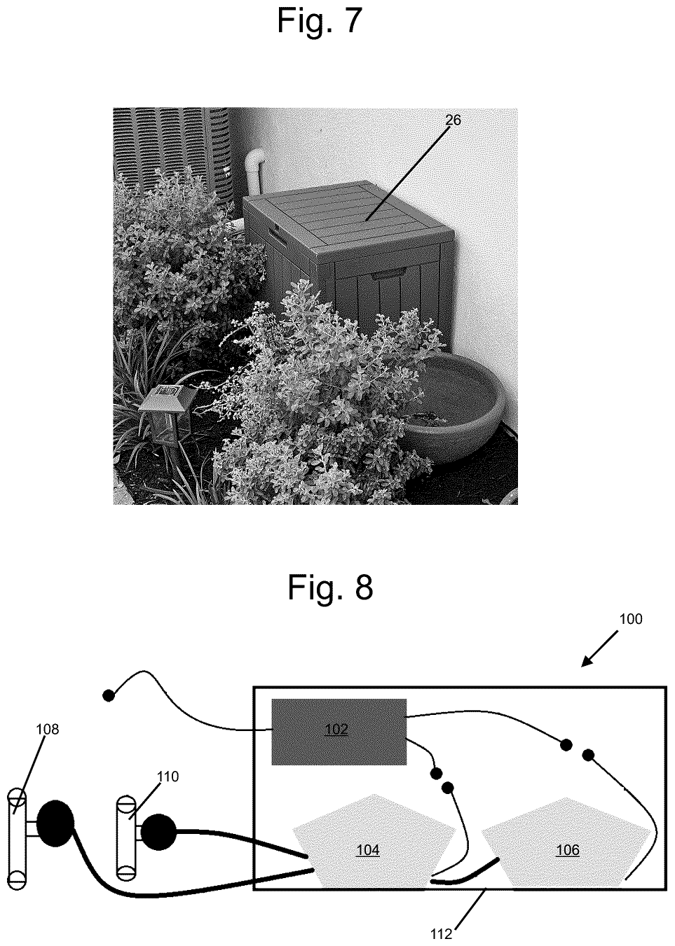

FIG. 6 shows an automated drainpipe clearing device 10 inside a case 26 with a lid 90 open. The vacuum source 12 and controller 14 are easily accessed by opening the lid 90. FIG. 7 shows the case 26 closed adjacent to a house. The case 26 allows the clearing device 10 to be inconspicuous.

FIG. 8 shows an alternative embodiment of an automated drainpipe clearing device 100 in accordance with principles of the invention. While the invention has been primarily discussed in relation to a drainpipe for an air-conditioning system, those skilled in the art will appreciate that this device may be utilized for clearing any type of drainpipe. Drainpipe clearing device 100 is very similar to drainpipe clearing device 10 except that is configured to maintain two drainpipes. It includes a controller 102 connected to two vacuum sources 104 and 106 which are connected to T junctions 108 and 110, respectively. The device 100 is housed within a case 112. T junctions 108 and 110 are the same as T junction 20 shown in FIGS. 1 and 2. Those skilled in the art will appreciate that it is a relatively simple matter to modify the controller 102 such that it is capable of operating two or more vacuum sources. The clearing device 100 and may be suitable for use when there is more than one drainpipe at a location. For example, rain gutters for directing the flow of rainwater off the roof of a building may also become clogged by leaves, twigs and other debris. In this embodiment, the vacuum source 106 may be more powerful in order to more effectively cleared debris from a range other rather than an air-conditioning drainpipe. The T junction 110 may be configured to be positioned in line with a rain gutter rather than a drainpipe. The invention may also similarly be used for routinely clearing other types of drains such as those for graywater.

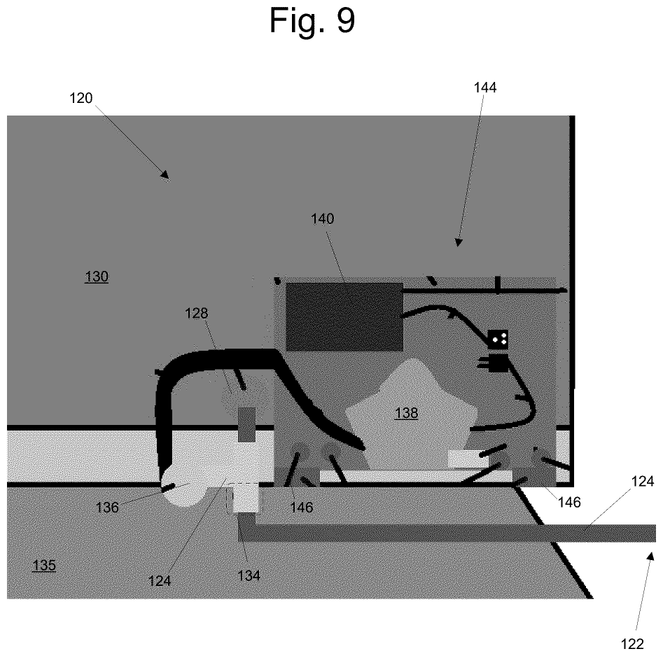

FIG. 9 shows another alternative embodiment of an automated drainpipe clearing device 120. In this embodiment, the T junction 124 is not located at the distal end 122 of the drainpipe 124 and is instead located upstream of the distal end 122. The drainpipe 124 was originally attached to a drain spout 128 protruding from the wall 130 of a building. The drainpipe 124 extends horizontally a substantial distance along the ground 135. Thus, a gravity actuated check valve would not operate consistently if it were placed at the distal end 122 of the drainpipe 124. Therefore, the T junction 124 is attached proximal and just downstream of the drain spout 128. The T junction 124 is substantially the same as T junction 20 and includes a check valve 134 that is substantially the same as check valve 18, although other types of check valves are also suitable as explained and described above. A suction conduit 136 is attached to the T junction and connects it to the vacuum source 138. The vacuum source 138 is operated by a controller 140 that regulates the frequency, duration and strength of the suction applied to the T junction 124. The controller 140 and vacuum source 138 are housed within a casing 144 which may be secured adjacent to the building by anchors 146. In this arrangement, it is possible for a clog to form downstream of the automated clearing device. However, the downstream portion of the drainpipe 122 may be detached and cleaned more easily than the drainage system upstream of the drain spout 128.

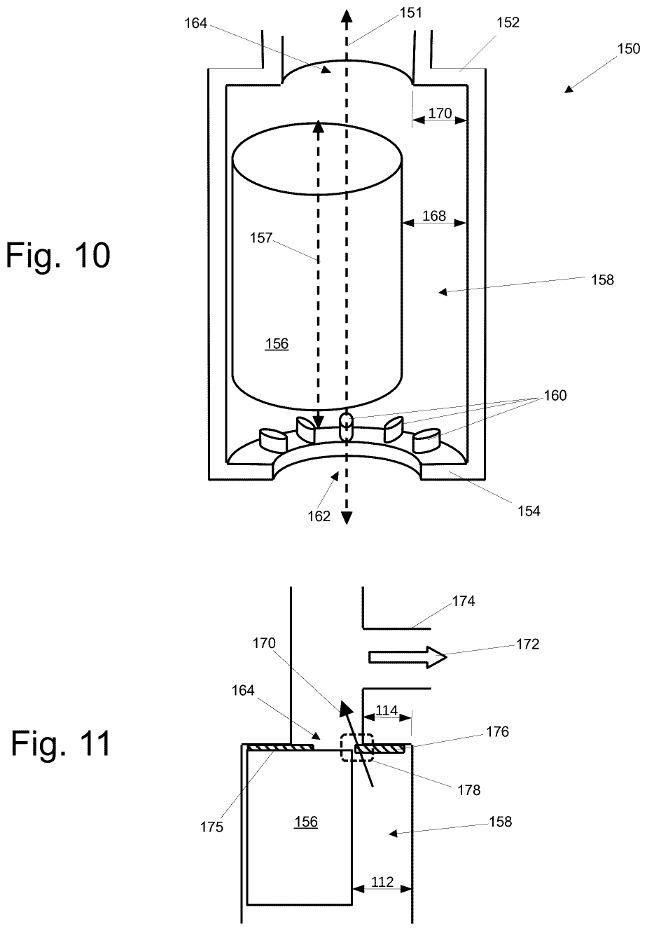

FIGS. 10-13 show alternative embodiments of check valves that are compatible with the other embodiments shown here in, as well as any other embodiments of the principles of the invention. The check valves described below are configured to be self-cleaning. Because the free-floating plug has substantially smaller dimensions than the chamber housing, it naturally rattles around inside the chamber, assisting and knocking loose any bioslime or other debris. The self-cleaning axial flow check valve with a free-floating plug of the invention further enhances the design and function of drainpipe clearing devices in accordance with principles of the invention. Like the other check valves disclosed herein, these check valves may also optionally be detached and/or disassembled in order to more thoroughly clean them. This is rarely if ever necessary for the check valves described below.

FIG. 10 shows a check valve 150 in accordance with the principles of the invention. Check valve 150, like check valves already described, is oriented such that it has a top 152 and a bottom 154, with a free-floating plug 156 housed in a flow chamber 158 and is maintained in the open position by gravity. It does not use a spring, solenoid or other mechanism to bias the plug 156. As used herein, “free-floating” refers to a plug of a check valve that is not connected to any other components, but rather is free to move in any direction within the flow chamber 158. The free-floating plug 156 has a substantially smaller width and cross-sectional area compared to the flow chamber 158. In this embodiment, both the flow chamber 158 and the plug 156 are cylindrical and have uniform widths. The width of the plug's top surface is between 15% and 35% smaller than the width of the chamber. In general, the ability of the free-floating plug to move vertically, horizontally and to rotate to an extent all facilitate removal of Bio slime and other debris from the interior chamber when the vacuum source is actuated. Generally, the plug should be configured such that it does not rotate more than 45° around a horizontal axis.

The flow chamber 158 includes a plurality of spacers 160 evenly distributed around the valve outlet 162 which consists of a relatively large opening in the center of the bottom 154. In this embodiment the spacers 160 have an oval or elliptical shape. Optionally, the spacers may have any configuration, and may also be hemispherical, parallelepipedal, prismatic, and the like, so long as they prevent the plug from closing off the outlet 162.

Those skilled in the art will appreciate that a grate, for example the grate 42 shown in FIG. 2, may be used in place of spacers, and the two structures are generally interchangeable. However, because the spacers as shown generally provide more numerous but smaller passageways for discharge drainage water. Therefore, the use of spacers may be preferable to prevent small animals such as insects from entering the drainage system, while still providing passageways sufficiently large to prevent them from getting clogged by bioslime or other debris. The plug 156 will spend the majority of its time resting atop the spacers 160. Therefore, it is generally preferable that the spacing between the plug 156 outlet 162 is sufficient to allow free flow of liquid and large enough to prevent small amounts of debris and/or bioslime from clogging the passageways.

This embodiment also shows the use of several spacers 160. The chamber 158 may have as few as one spacer, or as many as desired, so long as the passageways created are sufficiently sized for drainage to flow without clogging. The outlet 162 shown here is circular and centered in the bottom 154 of the chamber 158, i.e. concentric with the chamber 158. Those skilled in the art will appreciate that the outlet need not be located in the center of the bottom 154 and need not the circular. The outlet may even be located in the side or bottom corner of the chamber 158. However, those skilled in the art will appreciate that outlets that are centered at the bottom of the chamber are generally preferred to minimize collection of stagnant water in the chamber. It is also generally desirable for the plug 156 to have a substantially uniform width such that suction and gravity forces are both evenly distributed horizontally along the height of the chamber 158. Without being bound by theory, the inventor believes that this prevents low flow regions within the chamber that would allow Bio slime and/or debris to accumulate.

One of features of the axial flow check valve 150 is the fact that the plug 156 is not held in axial alignment with either of the inlet 164 and outlet 162. Plug 156 is capable of moving horizontally, i.e. transversely to the direction of flow, and there is no mechanism or particular configuration of the components that biases the plug 156 into axial alignment with the flow. FIG. 10 illustrates how the plug's axis of symmetry 157 is not co-linear with the axis of flow 151, which is aligned with the inlet 164, outlet 162, and the chamber as a whole 158. FIG. 10 does show the plug's axis 157 as parallel to the flow axis 151. However, those skilled in the art will appreciate that the plugs axis 157 is capable of rotating around any axis transverse to the flow axis 151.

One of the features of check valve 150 is the relative sizes of the plug 156, chamber 158 and the valve inlet 164 in the top 152 of the chamber 158. As shown in FIGS. 10 and 11, when the plug 156 is flush against one wall of the chamber 158, the distance from the plug to the opposing wall 168 is greater than the distance from the opposing wall to the lip of the opening 170. The plug may have a smaller diameter than is shown here, so long as the width of the plug 156 is greater than the width of the inlet 164. The plug 156 should have a width that covers at least about half or more of the inlet 164 when it lies flush against one side of the chamber 158. These comparative sizes will also depend in part on the strength of the vacuum source; a narrower plug requires more suction to be pulled partially over the inlet 164, and if a large amount of suction is required to lift the plug, then less suction will be applied upstream.

Referring to FIG. 11, because the plug 156 does not fully cover the inlet 164 when it lies flush against one side of the chamber 158, it can create a region 178 between the plug 156 and the inlet 164 that experiences a substantially higher amount of suction pressure 170 than the pressure 172 provided through suction conduit 174. This increased suction more effectively pulls bio slime 176 that has accumulated near the inlet 164. Were the plug 156 to completely cover the inlet 164, there would be no substantial suction applied, as is the case with bio slime agglomeration 175. Because the plug 156 floats freely within the chamber 158, it will move relative to the inlet 164, thereby clearing off different regions of the top 152 of the chamber 158. Those skilled in the art will appreciate that it may be desirable to rapidly oscillate the vacuum source between the off and on positions at some point during regularly scheduled cleaning. This encourages the plug 156 to rattle about the inside of the chamber, further loosening any accumulated bio slime and moving the region 178 around the rim of the inlet 164.

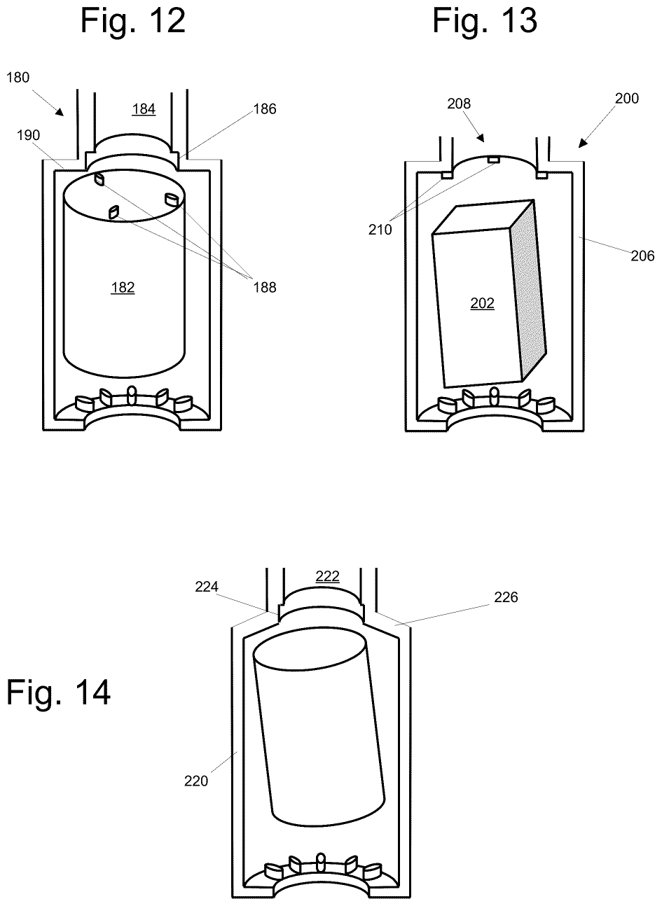

FIG. 12 shows another alternative embodiment of an axial flow check valve 180 having a free-floating plug 182 in accordance with the principles of the invention. Check valve 180 is very similar to check valve 150 except that the inlet 184 includes an annular shoulder 186 along the rim of the inlet 184. This configuration may improve removal of bio slime from the top 188 of the chamber 190. Without being bound by theory, the inventors believe this annular shoulder 186 allows a slightly wider cross-section to be exposed to the increased vacuum without decreasing the vacuum pressure. This slightly wider cross-sectional area improves the ability to remove bio slime. In addition, plug 182 includes three upper spacers 188. Spacers 188 are shorter than the spacers 160 of FIG. 10. These relatively small spacers prevent the top of the plug 182 from abutting flush against the top 190 of the chamber 180. As a result, stronger suction is applied along the entire rim of the inlet 184 to facilitate removal of any accumulated bio slime or other debris.

FIG. 13 shows another alternative embodiment of an axial flow check valve 200 having a free-floating plug 202 in accordance with principles of the invention. As explained above, it is not necessary for the plug 204 or the chamber 206 to have a cylindrical shape. In this embodiment, the plug 204 is a rectanguloid while the chamber is cylindrical. In this embodiment, spacers to 10 extends around the rim of the inlet 208. Like the spacers 188 in FIG. 12, the spacers as well as the shape of the plug 202 facilitate cleaning of the flow chamber by creating a region of increased suction around the edge of the inlet.

FIG. 14 shows another alternative embodiment of a flow chamber 220 in accordance with principles of the invention. In this embodiment, the inlet 222 has an annular shoulder 224 and the top 226 of the flow chamber 220 tapers upward from the walls of the chamber to the inlet 222. This configuration also may be Incorporated into check valves to improve removal of bio slime or other debris from the flow chamber 220.

As will be appreciated by those of skill in the art, the various configurations for axial flow check valves having free-floating plug shown in FIGS. 2, 10, 11, 12, 13 and 14 are generally interchangeable. For example, the plug 182 shown in FIG. 12 is readily used with any of the flow chambers of the other Figures. The same is true for the various spacers, inlet configurations and flow chamber configurations and these exemplary embodiments are illustrative and not intended to limit the invention to the configurations explicitly shown and described.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. An automated drainpipe clearing device comprising:
an inlet affixed to a downstream end of a drainpipe;
a suction conduit proximal to a downstream end of a drainpipe and in fluid communication with the drainpipe;
a vacuum source providing suction to the suction conduit;
a controller for activating the vacuum source for a predetermined time period at predetermined intervals;
an outlet downstream of the suction conduit having an check valve configured to close only when the vacuum source is activated.

2. The automated drainpipe clearing device of claim 1 wherein the check valve and suction conduit are incorporated into a T junction which may be attached to the downstream end of the drainpipe.

3. The automated drainpipe clearing device of claim 2 wherein the check valve comprises:
a flow chamber extending between an opening in a top of the flow chamber and an outlet at the bottom of the flow chamber; and,
a free-floating plug housed in the chamber;
wherein the valve at least partially closes when suction from the vacuum source pulls the plug upward such that a top surface of the plug at least partially covers the chamber inlet.

4. The automated drainpipe clearing device of claim 3 further comprising a plurality of vertical spacers around the outlet which prevent the plug from resting flush against the outlet.

5. The automated drainpipe clearing device of claim 4 wherein the plug has a uniform width.

6. The automated drainpipe clearing device of claim 5 wherein the plug does not completely cover the inlet when the plug is flush against an inside wall of the flow chamber.

7. The automated drainpipe clearing device of claim 6 wherein the plug is able to rotate along an axis transverse to an axis of flow up to about 45°.

8. The automated drainpipe clearing device of claim 3 wherein horizontal motion of the plug is not biased toward alignment with an axis of flow within the flow chamber.

9. The automated drainpipe clearing device of claim 8 wherein an annular shoulder surrounds the inlet.

10. The automated drainpipe clearing device of claim 8 wherein the top of the chamber defines a horizontal plane.

11. The automated drainpipe clearing device of claim 8 wherein the top of the chamber tapers upward from an inside wall of the flow chamber to the inlet.

12. The automated drainpipe clearing device of claim 8 wherein one or more spacers prevent the free-floating plug to lie flush against the inlet.
